(19) United States
(12) Patent Application Publication
(10) Pub. No.: US 2011/0320251 A1
(43) Pub. Date: Dec. 29, 2011

(54) System And Method For Performing A Redemption Transaction On A Point Of Sale Terminal

(75) Inventors: Fikret Ates, Namur (BE); Aziz Koufkouf, Brussels (BE); Christian Radu, Beauvechain (BE)

(73) Assignee: MASTERCARD INTERNATIONAL INCORPORATED, Purchase, NY (US)

(21) Appl. No.: 13/109,318

(22) Filed: May 17, 2011

Related U.S. Application Data
(63) Continuation of application No. PCT/US09/64848, filed on Nov. 17, 2009.
(60) Provisional application No. 61/115,376, filed on Nov. 17, 2008.

(51) Int. Cl. G06Q 30/00

(52) U.S. Cl. 705/14.17; 705/14.28

(57) ABSTRACT

A method and system for performing a redemption transaction at a point-of sale terminal. The cardholder initiates the transaction using a redemption card. The terminal obtains a transaction amount, a private currency, and an exchange rate. The transaction amount is converted into a transaction amount miles equivalent using the exchange rate, and the transaction amount miles equivalent is compared against the balance of the redemption account associated with the redemption card. The terminal transmits a clearing record for further processing. The clearing record is received by a clearing server, which identifies a lodged card associated with the transaction. The clearing server computes a periodic aggregate amount comprising the aggregate transaction amount for all transactions associated with the lodged card and a particular merchant during that period. The clearing server triggers a single transaction towards an acquirer associated with the merchant for the periodic aggregate amount.

### CROSS REFERENCE TO RELATED APPLICATIONS

This application is a continuation of International Patent Application No. PCT/US09/064,848, filed Nov. 17, 2009, which is based on and claims priority to U.S. Provisional Application Ser. No. 61/115,376, filed Nov. 17, 2008, both of which are incorporated herein by reference in their entirety for all purposes.

### BACKGROUND OF THE INVENTION

Over the past years, frequent flier programs have emerged as very successful. Frequent flier programs allow participants to accrue miles or similar loyalty currency based on desired behavior such as ticket purchases. Most of these programs offer their customers a redemption proposition that usually comprises a free ticket or ticket upgrade for earned miles. Some frequent flier programs also feature an option to buy goods or services with miles, in the form of a catalog with pre-selected goods or vouchers valid at predetermined shops.

Airlines who sponsor and host extensive, complex frequent flier programs for their customers need to carry the aggregate of unused but active miles as a liability on their balance sheet. Airlines have become increasingly sensitive towards this liability and are looking to create innovative propositions to increase miles spending.

A common example of such innovative propositions is the use of a dedicated acceptance brand to allow participants to buy goods and services in dedicated shops and catalogs via the Internet (e.g., WorldShop of Lufthansa). Additionally, some airlines have entered into a coalition with other loyalty programs whereby miles can be converted to points or vouchers. For example, Brussels Airlines with Points-Plus allows frequent fliers to convert their miles into points-plus which can be used to get vouchers in Delhaize outlets. Some airlines offer “experiential” awards and donations to charities and environmental groups.

### SUMMARY OF THE INVENTION

In one aspect, disclosed subject matter provides a computer-implemented method for processing a redemption transaction on a point of sale terminal comprising receiving transaction information, the transaction information comprising a transaction amount, instantiating communication with a redemption card, the redemption card comprising an IC chip, receiving an indication of a private currency associated with a redemption card, obtaining an exchange rate, the exchange rate defining the conversion ratio between the private currency and a terminal currency, determining, using the exchange rate, that a balance of a redemption account is sufficient to fund the transaction amount, and indicating approval of the transaction.

In another aspect, the disclosed subject matter provides a computer-implemented method for clearing a transaction at a clearing server comprising receiving a clearing record, the clearing record comprising a transaction amount, a card identifier, and a merchant identifier indicating a merchant associated with the transaction, identifying a lodged card associated with the transaction based on the card identifier, computing a periodic aggregate amount for mileage transactions associated with the lodged card and further associated with the merchant, the periodic aggregate amount comprising the transaction amount, and triggering a purchase transaction with the lodged card towards an acquirer associated with the merchant for the periodic aggregate amount.

In a further aspect, the disclosed subject matter comprises a point of sale terminal for processing a redemption transaction comprising a receiver configured to receive transaction information, the transaction information comprising a transaction amount, a communications unit configured to communicate with a redemption card, the redemption card comprising an IC chip, the communications unit further configured to receive an indication of a private currency associated with the redemption card, an exchange rate retrieval unit configured to obtain an exchange rate, the exchange rate defining the conversion ratio between the private currency and a terminal currency, a determination unit configured to determine, using the exchange rate, that a balance of a redemption account is sufficient to fund the transaction amount, and a display unit configured to indicate approval of the transaction.

### BRIEF DESCRIPTION OF THE DRAWINGS

FIG. 1 illustrates an exemplary embodiment of the stages of the redemption card program from the registration of the cardholder to the use of the card to make purchases.

FIG. 2 illustrates an exemplary embodiment of the transaction flow of a redemption transaction in which the redemption account is stored on a chip card.

FIG. 3 illustrates an exemplary embodiment of the display on the terminal screen during a redemption transaction.

FIG. 4 illustrates an exemplary embodiment of the transaction flow of a redemption transaction in which the redemption account is stored on a miles processor.

FIG. 5 illustrates an exemplary embodiment of the physical implementation of the approval and clearing network in which the clearing record is transmitted to a clearing server for processing.

FIG. 6 illustrates an exemplary embodiment of the clearing process used in connection with the disclosed subject matter.

FIG. 7 illustrates one embodiment of transactions received by the clearing server.

FIG. 8 illustrates an exemplary embodiment of the physical implementation of the approval and clearing network in which the clearing record is transmitted to a financial institution for processing.

### DETAILED DESCRIPTION OF THE DRAWINGS

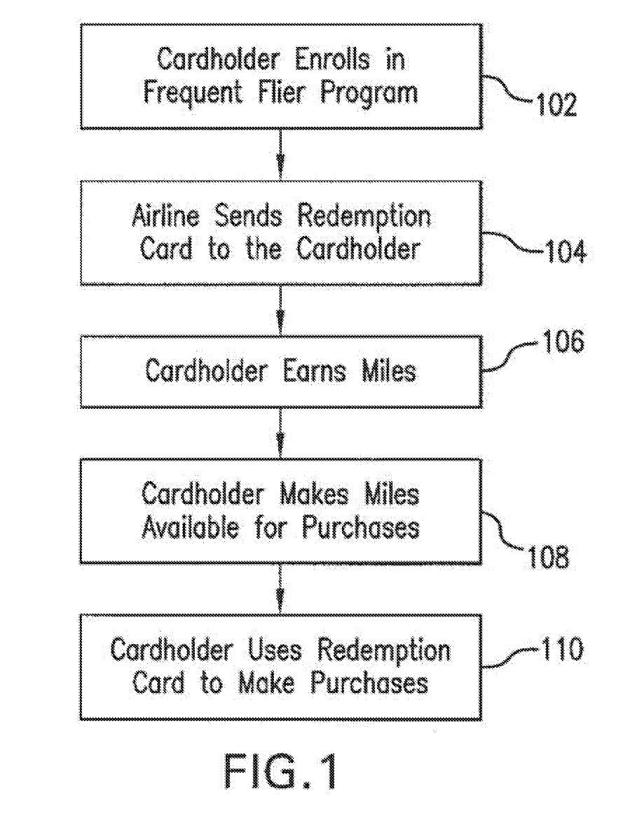

FIG. 1 illustrates an exemplary embodiment of the redemption card program from the creation of a loyalty program until the cardholder makes a purchase using a redemption card. First, the cardholder enrolls in a frequent flier program with an airline in 102. The specifics of the enrollment process will be handled by the airline and are outside the scope of this disclosure.

The airline then sends a redemption card to the cardholder in 104. The cardholder may also receive a website password for managing miles. The redemption card may include the cardholder's name and the PAN or other card identifier on the face of the card. The redemption card may also include an issuer's name and/or logo, an airline's name and/or logo, and security features such as a hologram. The redemption card may include a magstripe or an IC chip which may communicate using the contact pads on the chip, or contactlessly. The redemption card may be a card with at least one magstripe, a contactless chip or smart card such as a PayPass-type device. However, the redemption card is not limited to a “card” and may include any payment device, including mobile phones, smart phones, or any object containing a magstripe, chip or other communication interface. While the program will be described with reference to an IC chip card, those having skill in the art will recognize that the form of the redemption card may vary greatly without affecting the program, except where noted.

The redemption card may be a stand-alone card. The card may contain both a standard payment mechanism and a redemption mechanism. As used herein, standard payment mechanism refers to a credit card, a debit card, or any other payment mechanism known in the art. In such a one-card solution, each account has a different PAN or other card identifier and the cardholder may be prompted at the point of sale to indicate whether the standard payment mechanism or the redemption mechanism should be used. Alternatively, the cardholder may specify in advance when the redemption mechanism should be used. In another embodiment, the card may have two magstripes, and the cardholder determines whether to use the redemption mechanism by swiping the appropriate magstripe. In yet another embodiment, the redemption card may also act as the cardholder's frequent flier membership card.

The cardholder earns miles in 106. Once again, the process for earning miles is set by the airline and is outside the scope of this disclosure. The miles can be stored in the cardholder's frequent flier account. The cardholder then makes earned miles available for purchases in 108. For example, the cardholder may log on to the airline website and manage their miles by indicating that a certain number of miles should be made available for shopping. The cardholder may also be able to make miles available for purchases in-person, by telephone, by using an ATM, or by any other method known in the art. This allows the cardholder to have more control over the miles account, ensuring that miles the cardholder intends to redeem for an airline ticket are not used in other realms based on an accounting error or carelessness, thereby protecting the primary benefit of the frequent flier program. Alternatively, the program may be designed such that earned miles are deposited directly to a redemption account, or the cardholder may indicate that some or all earned miles should be deposited into the redemption account.

The airline may set rules governing the loading mechanism. For example, the airline may require that the cardholder have a minimum balance in the frequent flier account before loading miles into the redemption account. The airline may also place restrictions on the frequency of loading transactions or any other rules or restrictions desired by the airline.

Finally, the cardholder uses the redemption card to make purchases using miles in 110.

While the program is described in relation to a frequent flier program operated by an airline, those skilled in the art will recognize that the principles disclosed herein may be extended to other loyalty programs and other operating entities without departing from the scope of the invention.

### Using the Redemption Card to Makes Purchases

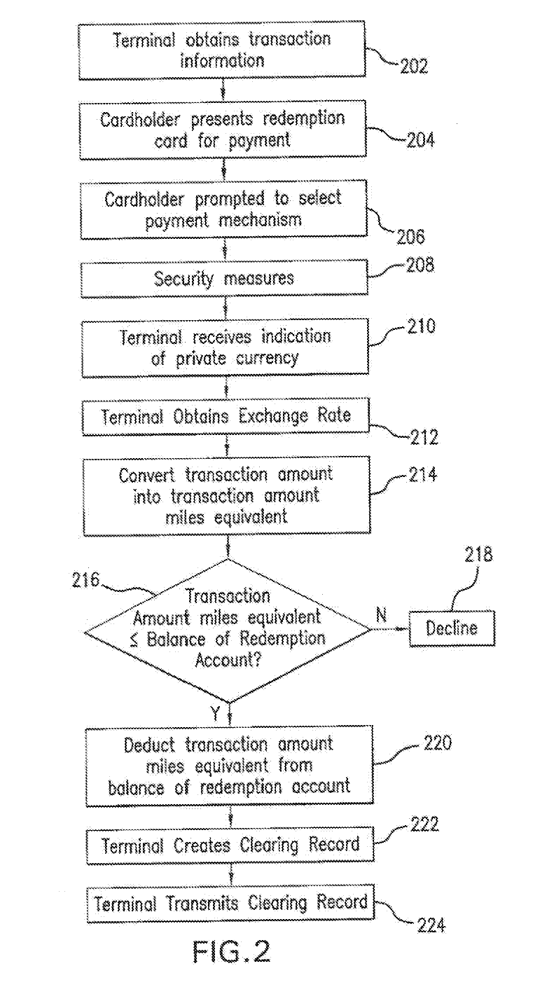

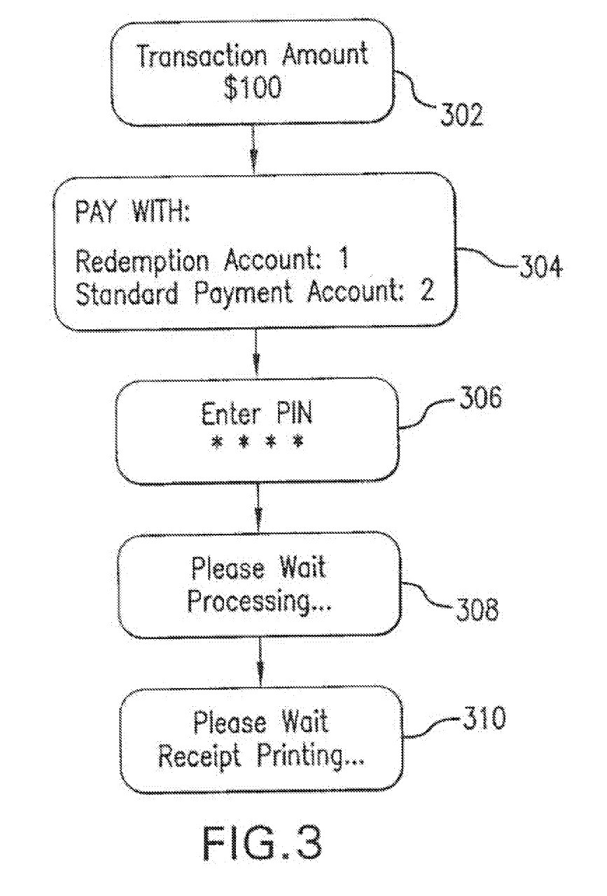

FIG. 2 illustrates the transaction flow of one embodiment of the disclosed authorization process. In the described embodiment, the redemption card contains an IC chip which stores a redemption account. The cardholder selects one or more items for purchase and the merchant processes the transaction as usual. The point-of-sale (POS) terminal obtains transaction information in 202. The terminal may receive the information at a receiver. Transaction information can include the transaction amount, the terminal currency, the date, the time, or any other information. Referring to FIG. 3, in one embodiment, the transaction amount is shown on the terminal screen in 302.

The POS terminal may include a display screen and an input mechanism. The input mechanism may be a keypad, a touch screen, or any other input mechanism known in the art.

Referring again to FIG. 2, the cardholder presents the redemption card for payment in 204. The redemption card may communicate with the terminal using a query-response standard such as EMV or by any other communication method and/or standard known in the art. Communication between the terminal and the chip card may be established by bringing the chip card into physical contact with the terminal or, in the case of a contactless chip card, bringing the chip card into proximity with the terminal.

In one embodiment, the redemption card contains a standard payment mechanism in addition to the redemption mechanism. In such an embodiment, the cardholder may be prompted to select which payment mechanism to use in 206. Referring to FIG. 3, one embodiment of the prompt is shown in 304. The cardholder can choose to pay using the redemption mechanism by selecting 1, or can use a standard payment mechanism by selecting 2. The redemption card and standard payment card can be labeled in any manner which differentiates between the functions. The displayed names are provided by the card and can be customized to meet any branding or other requirement. For example, the redemption card may be described with the name of the airline company or the name of the loyalty program, while the standard payment card may be described using a payment card name (e.g., MasterCard) or the name of the financial institution which issued the card.

For security reasons, chip cards may require additional authentication measures prior to use. Referring to FIG. 2, security measures are implemented in 208. The terminal may require the cardholder to enter a PIN to access the information on the chip card. The terminal may also require (in addition to or as alternative to a PIN) biometric information or any other security measures known in the art. The PIN may be compared against a PIN stored on the chip card to allow access to the card, or may otherwise be validated using any method known in the art. Referring to FIG. 3, the cardholder has entered a PIN in 306. After the PIN or other security measures are approved, the terminal may indicate that the transaction is being processed as in 308.

Referring again to FIG. 2, the terminal receives an indication of the redemption card's private currency in 210. Private currency refers to the currency held by the “realm” Airlines Company. More specifically, it refers to the miles distributed by a specific airline company, such that the private currency may be indicated by any method which communicates the identity of the airline company with which the redemption card is associated, unless the airline has multiple currencies (i.e., different exchange rates for certain cardholders or multiple frequent flier programs). The private currency may be used to identify the exchange rate between the private currency and the terminal currency, which is the currency accepted by the POS terminal. The terminal currency of the terminal illustrated in FIG. 3 is the dollar, as indicated in 302. Generally, the terminal currency will be the currency of the country where the terminal is located. However, the terminal currency may be a different currency chosen by the merchant, or the merchant may accept several different types of currencies depending on the selection of the customer.

The term “miles” as used herein is not limited to units called miles. “Miles” may be points, minutes, or any loyalty currency or other unit that represents an accumulation of value. Miles may also represent any non-conventional payment benefits such as vouchers, checques, or insurance money. However, miles are not intended to mean legal tender. A person skilled in the art will recognize that a large range of loyalty currency units may be used without departing from the scope of the invention.

After receiving an indication of the private currency, the terminal obtains an exchange rate between the private currency and the terminal currency in 212. The terminal may also obtain the exchange equation. The exchange rate S may be a parameter that describes how many units of the private currency are equivalent to one unit of the terminal currency. The exchange rate S may also define how many units of the terminal currency are equivalent to one unit of the private currency. In this embodiment, the exchange rate is used to calculate the transaction amount miles equivalent based on the exchange equation:

Amount_transaction(card)=Amount_transaction(terminal)/S (1)

where Amount_transaction(terminal) is the transaction amount in terminal currency and Amount_transaction(card) is the transaction amount in private currency, also referred to as the transaction amount miles equivalent. In this embodiment, S is the number of units of terminal currency equivalent to one unit of the private currency. This calculation may be performed by a conversion unit.

The terminal may obtain the exchange rate is a number of ways. In one embodiment, the exchange rate is stored in the terminal. The terminal and/or merchant network may be connected to a currency exchange server. The currency exchange server may be maintained by a payment network such as MasterCard, an issuing financial institution, or any other entity. Each airline company could send their exchange rates to the currency exchange server, which maintains all the exchange rates required by each airline company. The terminal could be updated through online communication when changes or additions are made to the exchange rates. A parameterization file with the most accepted airline companies' exchange rates may be downloaded by the terminal from the exchange server from time to time, thereby allowing offline operation. This embodiment would require no network or authorization server modifications and is scalable to a large number of merchants.

In another embodiment, the exchange rates may be stored by an authorization host such as the miles processor. This may occur where the redemption account is stored at the miles processor, which will be discussed in greater detail herein. In this embodiment, the network may have to be modified to accept non-ISO codes to identify the private currency.

In another embodiment, the exchange rates may be stored on the chip card. This method requires the use of a chip. The updating of the exchange rates may be done through scripts on the card.

Referring again to FIG. 2, the terminal uses the exchange rate and exchange equation to convert the transaction amount into the transaction amount miles equivalent in 214. As previously indicated, the transaction amount miles equivalent represents the number of miles the cardholder must have in the redemption account to complete the purchase. Alternatively, the terminal could convert the balance of the redemption account to a current balance cash equivalent, which represents the value of the miles stored in the redemption account converted into the terminal currency. In another embodiment, both the balance of the redemption account and the transaction amount can be converted into a third unit. For the purposes of the disclosed subject matter, the unit used for comparison is irrelevant. However, the transaction amount and the balance of the redemption account must be expressed in a common unit so that they can be directly compared.

The transaction amount miles equivalent is compared to the balance of the redemption account in 216. If the balance of the redemption account is less than the transaction amount miles equivalent, the terminal declines the transaction in 218 (or, alternatively, determines whether an alternate payment mechanism is available). Otherwise, the terminal approves the transaction. Upon approval, the redemption card updates the balance of the redemption account by deducting the transaction amount miles equivalent in 220. The terminal may determine whether the balance is sufficient to fund the transaction by receiving the balance from the redemption card and comparing it with the transaction amount miles equivalent. Alternatively, the terminal may determine whether the balance is sufficient to fund the transaction by transmitting the transaction amount miles equivalent to the redemption card and receiving an indication from the redemption card that the balance is sufficient.

The terminal creates a clearing record in 222. The clearing record may include the PAN of the card (or other card identifiers), PAN Sequence Number, Amount of the Transaction in the terminal currency code, date, time, and other information. The terminal transmits the clearing record for further processing in 224. The terminal may also print a receipt, as shown in 310 of FIG. 3.

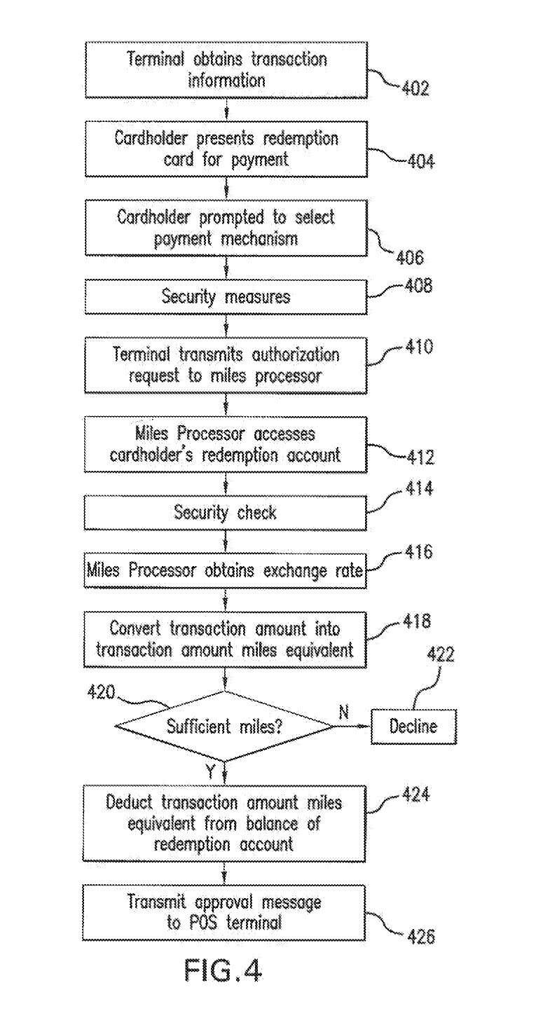

In another embodiment, the redemption account is stored on a miles processor which is in communication with the POS terminal. The redemption account may be stored on a miles processor where the redemption card does not contain a chip. FIG. 4 illustrates one embodiment of the disclosed subject matter in which the redemption account is stored on a miles processor. The POS terminal receives transaction information in 402. The cardholder presents the redemption card in 404, selects the payment mechanism (if necessary) in 406, and enters a PIN or other security information at 408.

The terminal processes this information and transmits an authorization request to the miles processor in 410. The authorization request may be transmitted directly to the miles processor, or it may be conveyed through one or more intermediaries such as an acquirer and/or a routing system. The authorization request may include a card identifier such as a PAN, the transaction amount, the terminal currency, security information such as a PIN, or any other information required by the miles processor. The authorization request and any other information sent over an open network may be encrypted using any method known in the art.

The miles processor uses the card identifier to access the cardholder's redemption account in 412. The miles processor then compares the provided security information against security information stored with or otherwise associated with the account in 414. If the security information is correct (e.g., if the provided PIN matches the stored PIN), the miles processor proceeds to determine whether the transaction should be authorized.

In order to authorize the transaction, the miles processor obtains the exchange rate in 416. The exchange rate defines the relationship between the terminal currency and the private currency, which may be stored in the redemption account maintained by the miles processor or may be stored at an external location such as a currency exchange server. The miles processor uses the exchange rate to convert the transaction amount into a transaction amount miles equivalent in 418.

The miles processor then determines whether the redemption account has sufficient miles to cover the transaction in 420. If the transaction amount miles equivalent is greater than the balance of the redemption account available for use, the transaction is declined in 422. The miles processor may transmit a decline message to the POS terminal, or may process the transaction using an alternate funding account if one is available. However, if the balance of the redemption account is greater than the transaction amount miles equivalent, the miles processor approves the transaction. Upon approval, the miles processor updates the balance of the redemption account by deducting the transaction amount miles equivalent in 424. The miles processor then transmits an approval message to the terminal in 426. The approval message may include the number of miles used for the transaction or an updated balance for the redemption account. This information may be displayed on the terminal or printed on the receipt.

### Clearance

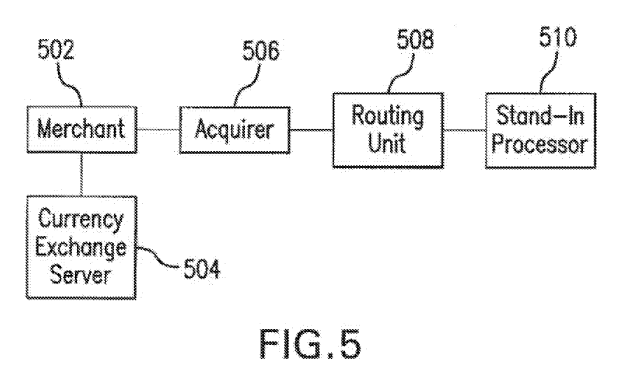

Referring again to FIG. 2, a clearing record is transmitted for further processing in 224. One embodiment of the approval and clearing network is illustrated in FIG. 5. The POS terminal located at the merchant 502 is communicably connected to the currency exchange server 504. The merchant is also communicably connected to an acquirer 506. The acquirer is further connected communicably to a stand-in processor 510 through a routing unit 508. The routing unit 508, stand-in processor 510, and currency exchange 504 server may be operated by a single entity, or each may be operated independently.

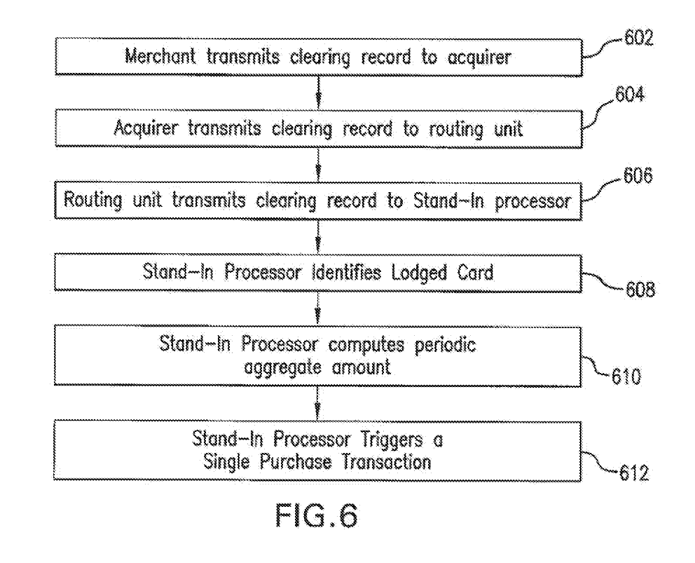

FIG. 6 describes one embodiment of the clearance process that can be used in connection with the system of FIG. 5. The merchant 502 transmits the clearing record to the acquirer 506 in 602. The acquirer 506 is a financial institution where the merchant 502 has a financial account. The money owed on the transaction will be paid to the merchant's financial account at the acquirer 506. The acquirer 506 then transmits the clearing record to the routing unit 508 in 604. The routing unit 508 may include any network or module which receives information and transmits it to the appropriate network or module for processing. The routing unit 508 then transmits the clearing record to a clearing server such as the stand-in processor 510 in 606. Other methods of transmitting the clearing record from the merchant 502 to the stand-in processor 510 may be used.

The stand-in processor is a processor which makes automatic payments on behalf of the airline company towards the merchants that accept the airline miles as payment. The airline registers a purchasing card or other payment mechanism with the stand-in processor. This purchase card may be any payment card suitable for making a large number and/or large dollar value of payments, such as a payment product currently offered by MasterCard for Business-to-Business payments. The term “lodged card” refers to an electronic representation of a physical card that resides in a processing system. For example, the lodged card may be a payment gateway, an electronic wallet, or any other electronic representation of the purchase card. The owner of the lodged card (here, the airline company) can give permission to the processing system to make a payment transaction on his/her/its behalf, conditioned on a number of contractual conditions being fulfilled or not violated.

The stand-in processor uses the clearing record to identify the lodged card associated with the transaction in 608. In one embodiment, the clearing record includes a card identifier. The card identifier may be a PAN or any other information that identifies the card used at the POS. In another embodiment, the clearing record includes an airline identifier, which identifies the airline and/or the specific lodged card which is to be used for clearance. The identity of the airline may be sufficient to identify the lodged card. However, if the airline has provided more than one lodged card (for example, to keep certain accounts separated for accounting or other purposes), the lodged card or the card used for the transaction must be identified. In one embodiment, the bank identification number (BIN) is extracted from the PAN of the card to identify the lodged card with which the company is linked.

The stand-in processor then computes a periodic aggregate amount in 610. The aggregate amount is associated with both a lodged card and a merchant, such that the periodic aggregate amount represents the amount that will be paid to a specific merchant by using a specific lodged card over the period. The aggregate amount may be calculated at any period determined by the stand-in processor, the airline, or the merchant. For example, the aggregate amount may be calculated hourly, daily, weekly, yearly, or at any other interval.

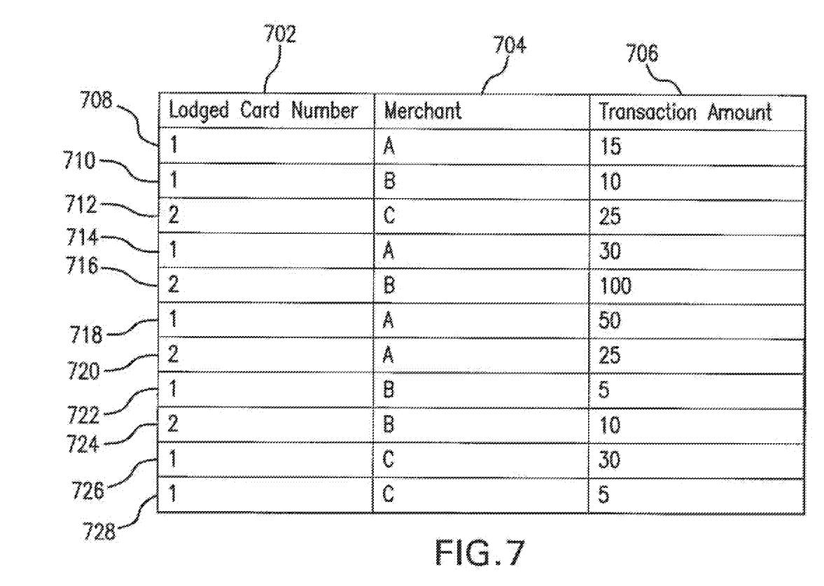

FIG. 7 shows a list of transactions that may be received by the stand-in processor and will be used to describe the calculation of the aggregate amounts. For sake of simplicity, the system contains only two lodged cards, 1 and 2, which may be lodged cards associated with Airline 1 and Airline 2, respectively. The transactions are received from merchants A, B, and C (or, more accurately, the transactions are processed at terminals associated with and clearing reports are received from merchants A, B, and C). Thus, six aggregate amounts will be calculated. The lodged card associated with a transaction is identified in column 702, the merchant associated with the transaction is identified in column 704, and the transaction amount is identified in column 706. Rows 708-728 list individual transactions.

The aggregate amount associated with a lodged card x and a merchant y is calculated as the sum of the transaction amount for all transactions associated with lodged card x and merchant y. To calculate the aggregate amount associated with lodged card 1 and merchant A, the stand-in processor may first identify the transactions associated with these parameters. Rows 708, 714, and 718 would be identified. The stand-in processor then calculates the sum of the transaction amounts for each identified row. The stand-in processor would thus calculate the aggregate amount as $95. Alternatively, the stand-in processor may keep a running total of the aggregate amount and augment the total as the clearing reports are received. If FIG. 7 represents all the transactions for a given period, the periodic aggregate amount associated with lodged card 1 and merchant A would be $95.

Finally, the stand-in processor triggers a single purchase transaction with the lodged card towards the acquirer for the periodic aggregate amount in 612. For example, referring again to FIG. 7, the stand-in processor would trigger a single purchase transaction for $95 with lodged card 1 towards the acquirer associated with merchant A. The term “trigger” indicates that the purchase card is used to pay the acquirer for the original transaction at the point-of-sale. Thereafter, transaction may be cleared between the acquirer and the airline company.

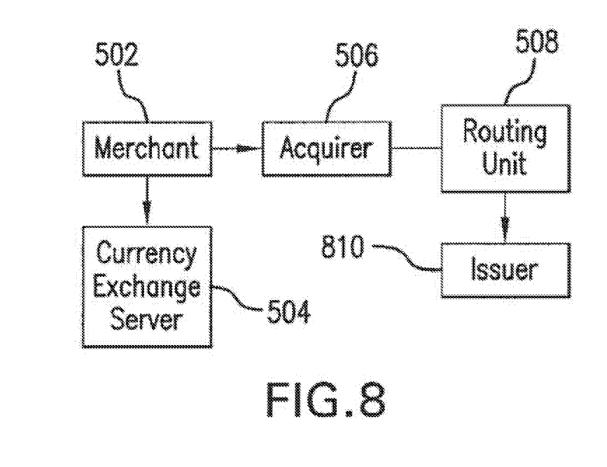

Referring to FIG. 8, in another embodiment the routing unit 508 transmits the clearing record to the issuing financial institution 810. The issuing financial institution then settles with the acquirer in the standard manner, and bills the airline for all transactions made against the cardholder's redemption card account.

In another embodiment, the transaction is cleared after the transaction is authorized by the miles processor. Authorization by the miles processor was previously described in relation to FIG. 4. The clearing record may be generated by the miles processor and sent to the stand-in processor or the issuing financial institution, either directly or through an intermediary such as the routing unit. Alternatively, the clearing record may be generated by the POS terminal after receiving the authorization message, in which case the transaction can be cleared though the same process described above with in relation to FIGS. 5 through 8.

The foregoing merely illustrates the principles of the disclosed subject matter. Various modifications and alterations to the described embodiments will be apparent to those skilled in the art in view of the inventors' teachings herein. Features of existing payment methods and loyalty programs can be seamlessly integrated into the exemplary embodiments of the present invention. It will thus be appreciated that those skilled in the art will be able to devise numerous systems and methods which, although not explicitly shown or described herein, embody the principles of the disclosed subject matter and are thus within its spirit and scope.

What is claimed is:

1. A computer-implemented method for processing a redemption transaction on a point-of-sale terminal comprising:
receiving transaction information, said transaction information comprising a transaction amount;
instantiating communication with a redemption card, said redemption card comprising an IC chip;
receiving an indication of a private currency associated with said redemption card;
obtaining an exchange rate, said exchange rate defining the conversion ratio between said private currency and a terminal currency;
determining, using said exchange rate, that a balance of a redemption account is sufficient to fund said transaction amount; and
indicating approval of said transaction.

2. The method of claim 1, wherein said obtaining an exchange rate comprises retrieving an exchange rate stored on said terminal.

3. The method of claim 2, wherein said redemption transaction is processed offline.

4. The method of claim 2, further comprising:
receiving said exchange rate from a currency exchange server; and
storing said exchange rate on said terminal.

5. The method of claim 3, wherein said receiving said exchange rate from said currency exchange server comprises receiving real time updates of changes made to said exchange rate at said currency exchange server.

6. The method of claim 3, wherein said receiving said exchange rate from said currency exchange server comprises periodically receiving updates to changes made to said exchange rate at said currency exchange server, and wherein said redemption transaction is processed offline.

7. The method of claim 1, wherein said determining that a balance of a redemption account is sufficient to fund said transaction amount comprises:
converting said transaction amount into a transaction amount miles equivalent using said exchange rate;
transmitting said transaction amount miles equivalent to said redemption card; and
receiving an indication that said balance of said redemption account stored on said redemption card is greater than or equal to said transaction amount miles equivalent

8. The method of claim 1, wherein said determining that a balance of a redemption account is sufficient to fund said transaction amount comprises:
converting said transaction amount into a transaction amount miles equivalent using said exchange rate;
receiving said balance from said redemption card; and
comparing said balance to said transaction amount miles equivalent.

9. The method of claim 1, further comprising:
prompting a cardholder to enter security information;
receiving security information from said cardholder; and
authenticating said cardholder based on said security information.

10. The method of claim 9, wherein said security information comprises a personal identification number.

11. The method of claim 9, wherein said security information comprises biometric information.

12. The method of claim 1, further comprising:
creating a clearing record, said clearing record comprising a transaction amount; and
transmitting said clearing record for further processing.

13. A computer-implemented method for clearing a transaction at a clearing server comprising:
receiving a clearing record, said clearing record comprising a transaction amount, a card identifier, and a merchant identifier, said merchant identifier indicating a merchant associated with said transaction;
identifying a lodged card associated with said transaction based on said card identifier;
computing a periodic aggregate amount for mileage transactions associated with said lodged card and further associated with said merchant, said periodic aggregate amount comprising said transaction amount; and
triggering a purchase transaction with said lodged card towards an acquirer associated with said merchant for said periodic aggregate amount.

14. The method of claim 13, wherein said card identifier comprises a personal account number.

15. The method of claim 13, wherein said periodic aggregate amount comprises a daily aggregate amount.

16. The method of claim 13, wherein said lodged card comprises an electronic wallet.

17. The method of claim 13, wherein said lodged card comprises a payment gateway.

18. The method of claim 13, wherein said transaction comprises a redemption transaction.

19. A point of sale terminal for processing a redemption transaction comprising:
a receiver configured to receive transaction information, said transaction information comprising a transaction amount;
a communications unit configured to communicate with a redemption card, said redemption card comprising an IC chip, said communications unit further configured to receive an indication of a private currency associated with said redemption card;
an exchange rate retrieval unit configured to obtain an exchange rate, said exchange rate defining the conversion ratio between said private currency and a terminal currency;
a determination unit configured to determine, using said exchange rate, that a balance of a redemption account is sufficient to fund said transaction amount; and
a display unit configured to indicate approval of said transaction.

20. The terminal of claim 19, further comprising an exchange rate database configured to store one or more exchange rates, wherein said exchange rate retrieval unit is configured to retrieve said exchange rate.

21. The terminal of claim 20, wherein said terminal is offline.

22. The terminal of claim 19, wherein said receiver is further configured to receive said exchange rate from a currency exchange server.

23. The terminal of claim 19, wherein said determination unit comprises a conversion unit configured to convert said transaction amount into a transaction amount miles equivalent, and wherein said communication unit is further configured to transmit said transaction amount miles equivalent to said redemption card and to receive an indication that said balance of said redemption card is greater than or equal to said transaction amount miles equivalent.

24. The terminal of claim 19, wherein said determination unit comprises a conversion unit configured to convert said transaction amount into a transaction amount miles equivalent using said exchange rate and a comparison unit configured to compare said balance to said transaction amount miles equivalent, said communications unit further configured to receive said balance of said redemption account from said redemption card.

25. The terminal of claim 19, further comprising:
a display configured to prompt a cardholder to enter security information;
an input unit configured to allow a cardholer to input security information; and
an authentication unit for authenticating said cardholder based on said security information.
